(19) United States
(12) Patent Application Publication
(10) Pub. No.: US 2015/0128432 A1
(43) Pub. Date: May 14, 2015

(54) Slidable Alignment Apparatus

(71) Applicant: Jonathon Jacob Penneman, Springfield, OR (US)

(72) Inventor: Jonathon Jacob Penneman, Springfield, OR (US)

(21) Appl. No.: 14/075,758

(22) Filed: Nov. 8, 2013

(51) Int. Cl. G01C 9/34; B25H 7/00

(52) U.S. Cl. CPC G01C 9/34; B25H 7/00
USPC 33/381

(57) ABSTRACT

A slidable apparatus with adjustable length for aligning and marking spaced apart points for fastening means, such as nails and hooks, for hanging objects is disclosed. The apparatus comprises at least two elongate members and at least one bubble level. The elongate members are slidable relative thereto, each having a first end and a second end. The first ends each have a stopper to stop sliding the elongate members when the apparatus is at its maximum length. The second ends each have a marking member. The at least one bubble level either has a fixed position or adjustable positions to allow rotating of the at least one bubble level.

### BACKGROUND

1. Field of the Invention

This invention relates to an apparatus for aligning and marking at least two spaced apart points accurately and easily for the purpose of hanging objects, for example, on a wall.

2. Background of Related Art

As known in the prior art, a person trying to hang one or more objects, for example, on a wall, can do so in a simple and precise manner by using an alignment device having a long bar or a frame along which certain marking mechanisms, such as boreholes or perpendicular arms attached to the long bar or frame, slides or guides to reach the desired distance. Such prior art devices are long, bulky, and/or heavy, making it difficult for a user to carry around such devices. Carrying such devices around requires much space for the long length and bulky shape. Heaviness of such devices can easily tire a user. However, reducing the length or size of such prior art devices will result in the loss of the use of such prior art devices because the large range of distance between the marking mechanisms for the spaced apart points cannot exist without the long or bulky bar or frame, hence defeating the purpose of such devices.

What is needed is an apparatus that not only is light in weight and compact in size for easy and convenient carrying when the apparatus is not in use, but also has a large range of adjustable length when the apparatus is being used. A need also exists for alignment devices of low costs of manufacture for purchase.

### SUMMARY

The invention is directed to an apparatus that satisfies the need of an alignment apparatus with compact size and yet a large range of adjustable length. The apparatus comprises a first and an at least second elongate member and at least one bubble level. The at least one bubble level is mounted in at least one of the elongate members. The elongate members each have a first and a second end. The elongate members on both sides in a longitudinal direction have respective connecting longitudinal edges which cooperate in order to allow sliding of the first and the at least second elongate members relative thereto along the longitudinal direction without visible space therebetween. At least one of the elongate members has a groove along the longitudinal direction. The first ends of the first and the second elongate members each have a stopper sliding in the groove or grooves while the first and the second elongate members slide relative thereto, whereas the stoppers stop sliding of the first and the second elongate members when the apparatus is at its maximum length. The second ends of the first and the second elongate members each have at least one marking member.

In one embodiment, the at least one marking member of the apparatus is a refillable or replaceable marker.

In one embodiment, the at least one marking member of the apparatus is a borehole.

In one embodiment, the at least one bubble level of the apparatus has at least two adjustable positions in order to allow rotating of the at least one bubble level 360 degrees around its center point.

In some embodiments, the elongate members are between 0.01 mm and 1.00 cm in thickness.

In one embodiment, the second ends of the elongate members of the apparatus are in the shape of an isosceles trapezoid having a substantially short upper base and a lower base that are parallel to each other and perpendicular to the longitudinal direction. The second ends of the first and the second elongate members taper in a direction remote from the apparatus. In one embodiment, the at least one marking member is located on the upper base of the isosceles trapezoid.

### BRIEF DESCRIPTION OF THE DRAWINGS

FIG. 1 illustrates one embodiment of the invention with second ends being rectangular, shown from an elevational view of the front side of the apparatus with the apparatus oriented horizontally.

FIG. 2 is a cross-sectional view, taken along the II-II line of the apparatus of FIG. 1.

FIG. 3 illustrates one embodiment of the invention from a perspective view of the apparatus with second ends of first and second elongate members shaped as isosceles trapezoids and bubble levels having adjustable positions that allow bubble levels to rotate 360 degrees.

FIG. 4 is an exploded perspective view of one embodiment of the apparatus with bubble levels each having one fixed position.

FIG. 5 illustrates one embodiment of the invention in an elevational view of the front side of the apparatus with the apparatus oriented vertically.

It is understood that drawings are for illustration only and are not limiting.

### DETAILED DESCRIPTION OF THE DRAWINGS

Turning now, in detail, to an analysis of the drawing figures, apparatus 101 of the invention comprises two elongate members 102 and 103, which on both sides in a longitudinal direction have respective connecting longitudinal edges 107 that cooperate in order to allow sliding of elongate members 102 and 103 relative thereto along the longitudinal direction without visible space therebetween.

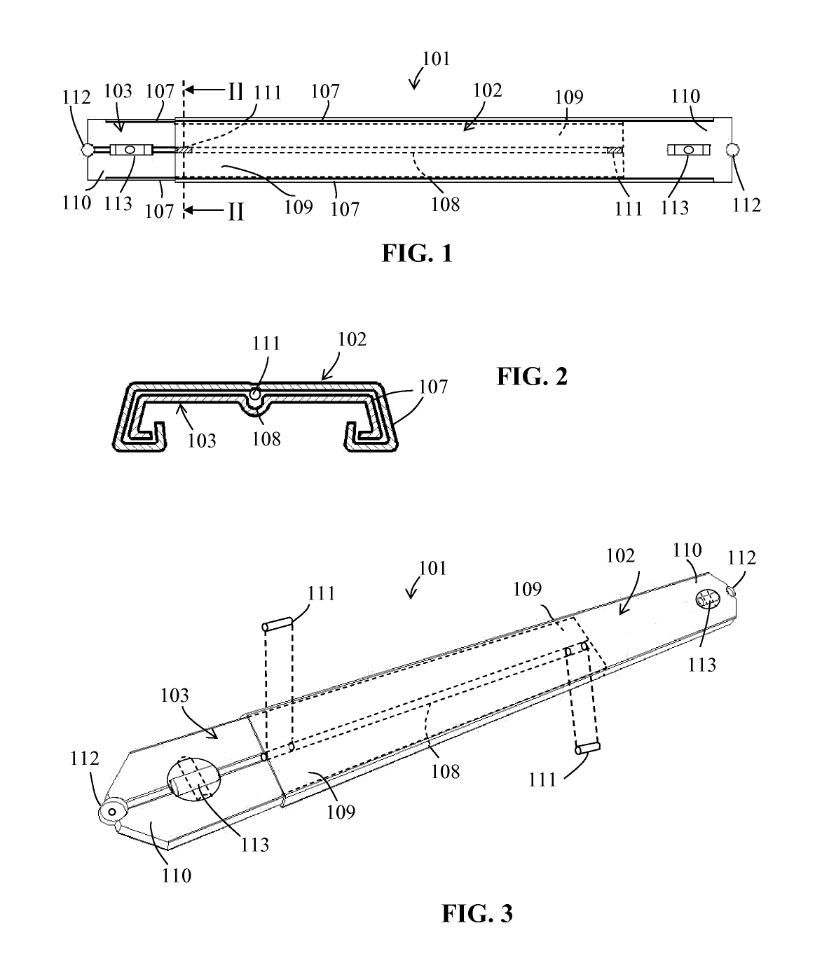

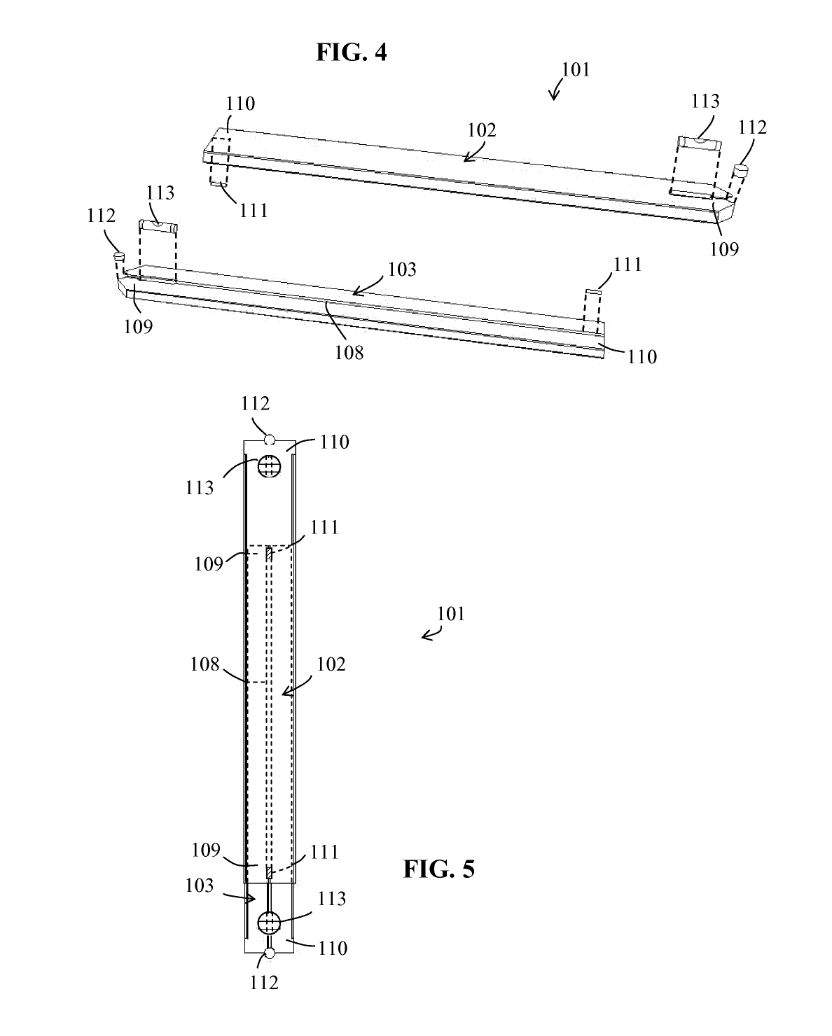

Apparatus 101 further comprises one or more bubble levels 113, the preferred number of which is two. In one embodiment as illustrated in FIGS. 1 and 4, bubble levels 113 are fixed and do not have adjustable rotating positions. In other embodiments, as illustrated in FIGS. 3 and 5, bubble levels 113 have at least two adjustable positions such that bubble levels 113 can rotate 360 degrees around their center points.

At least one of elongate members 102 and 103 has a groove 108 along the longitudinal direction, preferably located at the longitudinal central line of elongate members 102 and 103. Elongate members 102 and 103 also each have two ends, with first ends 109 each having a stopper 111 sliding in groove 108 while elongate members 102 and 103 slide relative thereto, and with second ends 110 each having a marking member 112, whereas stoppers 111 stop sliding of elongate members 102 and 103 when apparatus 101 is at its maximum length. In one embodiment marking members 112 are boreholes as illustrated in FIG. 3, and in another embodiment marking members 112 are refillable or replaceable markers, and in yet another embodiment marking members 112 are pushable pins.

In one embodiment, second ends 110 of elongate members 102 and 103 are in the shape of a rectangle or a square as illustrated in FIGS. 1 and 5, and in some embodiments, second ends 110 are in the shapes of, including without limitation an isosceles triangle, a half of a circle, or an isosceles trapezoid tapering in a direction remote from apparatus 101 as illustrated in FIGS. 3 and 4.

Turning now to an example of using apparatus 101 by an individual user for aligning spaced apart points on a wall. FIG. 1 illustrates the orientation of apparatus 101 when it is used for aligning horizontally spaced apart points at exactly the same height on a wall, and FIG. 5 illustrates the orientation of apparatus 101 when it is used for aligning vertically spaced apart points along a perfectly vertical line on a wall, in each of which cases with elongate member 103 touching the wall and elongate member 102 facing the user. The user first determines the distance between the spaced apart points on a wall by sliding elongate members 102 and 103 and comparing the distance between marking members 112 with the desired distance, for example, the distance between the hangers or hooks on the item to be hanged, until the distance between marking members 112 is the same as the desired distance. Without adjusting the length of apparatus 101 the user may adjust the position of bubble levels 113 by rotating bubble levels 113, if needed, and then hold apparatus 101 against the wall in a way that bubble levels 113 are leveled, at which time the user uses marking members 112 to make marks on the wall. The user then removes apparatus 101 and may need to repeat some or all of the steps, for example, to align multiple sets of spaced apart points. After all spaced apart points on the wall are marked by marking members 112, the user then hammers fastening means as marked by the marks. After all the fastening means are hammered in, the user then hangs the item(s) onto the appropriate fastening means.

When apparatus 101 is not used, the user can simply slide elongate members 102 and 103 towards each other until they are stopped from sliding by bubble levels 113, at which point apparatus 101 is at its minimum length, almost half of the maximum length of apparatus 101. The user can easily carry apparatus 101 in a compact-size tool bag or tool box.

In order for apparatus 101 to be most effective when used, there are certain preferred features for elongate members 102 and 103. Preferably, elongate members 102 and 103 are substantially thin and are made out of light-weight materials.

It is noted that, as used in this specification and the appended claims, the singular forms “a,” “an,” and “the,” include plural referents unless expressly and unequivocally limited to one referent. Thus, for example, reference to “a rectangle” includes two or more different rectangles. As used herein, the term “include” and its grammatical variants are intended to be non-limiting, such that recitation of items in a list is not to the exclusion of other like items that can be substituted or other items that can be added to the listed items.

Upon studying the disclosure, it will be apparent to those skilled in the art that various modifications and variations can be made in the apparatus 101 of various embodiments of the invention. Other embodiments will be apparent to those skilled in the art from consideration of the specification and practice of the embodiments disclosed herein. It is intended that the specification and examples be considered as examples only. The various embodiments are not necessarily mutually exclusive, as some embodiments can be combined with one or more other embodiments to form new embodiments.

What is claimed is:

1. An apparatus for aligning at least two spaced apart points, comprising
a first and an at least second elongate member, each having a first and a second end, the first and the at least second elongate members on both sides in a longitudinal direction having respective connecting longitudinal edges which cooperate in order to allow sliding of the first and the at least second elongate members relative thereto along the longitudinal direction without visible space therebetween, at least one of the elongate members having a groove along the longitudinal direction, the first ends of the first and the second elongate members each having a stopper sliding in the groove while the first and the second elongate members slide relative thereto, whereas the stoppers stop sliding of the first and the second elongate members when the apparatus is at its maximum length, the second ends of the first and the second elongate members each having at least one marking member; and
at least one bubble level being mounted in at least one of the elongate members.

2. The apparatus according to claim 1, wherein the at least one marking member is a refillable or replaceable marker.

3. The apparatus according to claim 1, wherein the at least one marking member is a borehole.

4. The apparatus according to claim 1, wherein the at least one bubble level has at least two adjustable positions in order to allow rotating of the at least one bubble level 360 degrees around its center point.

5. The apparatus according to claim 1, wherein each of the elongate members is between 0.01 mm and 1.00 cm in thickness.

6. The apparatus according to claim 1, wherein the second ends of the first and the second elongate members are shaped as an isosceles trapezoid having a substantially short upper base and a lower base that are parallel to each other and perpendicular to the longitudinal direction, the second ends of the first and the second elongate members tapering in a direction remote from the apparatus.

7. The apparatus according to claim 6, wherein the at least one marking member is located on the upper base of the isosceles trapezoid.
